(19) United States
(12) Patent Application Publication
(10) Pub. No.: US 2010/0240943 A1
(43) Pub. Date: Sep. 23, 2010

(54) DEGRADATION OF ORGANIC POLLUTANTS IN AN AQUEOUS ENVIRONMENT USING CORONA DISCHARGE

(76) Inventors: Dvir SOLNIK, Yessod Hamaala (IL); Itay EVEN EZRA, Atlit (IL); Yakov E. KRASIK, Nesher (IL)

Correspondence Address: Pearl Cohen Zedek Latzer, LLP, 1500 Broadway, 12th Floor, New York, NY, 10036, US

(21) Appl. No.: 12/727,768

(22) Filed: Mar. 19, 2010

Related U.S. Application Data
(60) Provisional application No. 61/161,600, filed on Mar. 19, 2009.

(51) Int. Cl. C02F 1/48; A62D 3/10; A62D 3/19; B01J 19/08

(52) U.S. Cl. 588/311; 204/554; 204/673; 204/660

(57) ABSTRACT

An electrode includes an elongated conductive metal support and a layer of carbon fibers supported by, and in electrical contact with, the elongated conductive metal support such that ends of fibers of the layer of carbon fibers extend beyond the conductive metal support.

### CROSS REFERENCE TO RELATED APPLICATIONS

The present invention claims the benefit of U.S. Provisional Patent Application No. 61/161,600 filed Mar. 19, 2009, which is incorporated in its entirety herein by reference.

### FIELD OF THE INVENTION

The present invention relates to water purification. More particularly, the present invention relates to degradation of organic pollutants in an aqueous environment using corona discharge.

### BACKGROUND OF THE INVENTION

The increasing need for water that is purified from various pollutants has promoted the development of water treatment technologies. Often, the pollutants are in the form of chemical contaminants. Conventional water treatment methods based on separation principles, such as activated carbon and air stripping, are often not effective in the removal of such contaminants. Their high solubility and other physical and chemical characteristics may make it difficult to achieve a safe concentration with a separation method alone. Therefore, in addition to, or alternatively to, removing the contaminant from water to be purified, a destructive process may be needed to degrade a contaminant into less harmful compounds.

For example, various advanced oxidation technologies (AOT) have been developed particularly for the removal of refractory volatile organic compounds (VOC). For example, a VOC may enter a water supply as a by-product, or as a direct product, of various industrial applications. Such VOCs may include, for example, trichloroethylene (TCE), ethyl tert-butyl ether (MTBE), and N-Nitrosodimethylamine (NDMA). AOT processes have also been developed for removing endocrine disrupting chemicals (EDC) such as, for example, pharmaceuticals and hormones.

AOT processes are designed to expose the water to be purified to highly reactive oxidizing species, such as, for example, hydroxyl (OH) radicals, ozone (O₃), or hydrogen peroxide (H₂O₂), or to ultraviolet (UV) radiation. Common AOT systems are based on UV radiation applied together with H₂O₂, or on ozone gas (O₃) combined with H₂O₂. Direct corona discharge over polluted water may also produce oxidizing agents for use in an AOT process. For example, direct corona discharge may produce OH radicals, UV radiation, O₃ gas, and H₂O₂. The dense, non-thermal plasma that may be formed in the vicinity of corona electrodes typically produces intense UV radiation and energetic electrons. The UV radiation and energetic electrons acting on the air, in turn, could generate O₃, free radicals and H₂O₂. Application of corona discharge to production of AOT products may assist in overcoming some of the drawbacks related to conventional AOT processes. For example, corona discharge may reduce or eliminate requirements for a gas exchange system, for a supply of pure oxygen (for an ozone-based system), or for a UV lamp and its associated cooling system. Thus maintenance requirements and costs may be reduced.

For example, Locke et al. in US 2005/0011745 describe an AOT process that utilizes pulsed corona discharge in the liquid phase. However, various technical difficulties have thus far inhibited wide use of corona discharge systems for water purification Improved corona discharge systems for purifying water have been described by Ryazanova et al. in U.S. Pat. No. 6,802,981 and by Krasik in WO 2009/069117. Electrodes for corona discharge with improved lifetimes have been described by Krasik in US 2008/0233003.

N-Nitrosodimethylamine (NDMA) is a well-known and extremely potent carcinogen and mutagen. NDMA has been shown to be formed as a byproduct of chlorination disinfection processes in drinking water and wastewater. NDMA has also been found in ground and surface water as a result of industrial pollution. NDMA is highly soluble and cannot be removed from water by granular activated carbon (GAC) or air stripping. Therefore, treatment of NDMA-tainted water by photo-oxidation (UV radiation with hydrogen peroxide) has been recommended as the best available technology (BAT). However, application of UV radiation with hydrogen peroxide may not be effective when applied to turbid water. For example, the presence in the water of any of a large variety of organic and inorganic compounds that absorb UV radiation may reduce the effectiveness of the treatment. Furthermore, UV lamps typically require routine cleaning and replacement, and may contain materials that require special disposal, such as mercury. The provision of hydrogen peroxide may incur additional costs. Also, hydrogen peroxide is considered to be a hazardous material so that storage or transportation of hydrogen peroxide near residential areas may be restricted.

A typical measure of the efficiency of a water treatment method is the electrical energy per order (EEO). EEO is defined as the quantity of electrical energy (in kilowatt-hours) applied to a cubic meter of water that is required to reduce the concentration of a pollutant by one order of magnitude (units of kW.h.order⁻¹.m⁻³). A low EEO value implies a high efficiency. For example, typical EEO values for NDMA photolysis range from 1 kW.h.order⁻¹.m⁻³ to 1.9 kW.h.order⁻¹.m⁻³. Thus, a treatment that has similar a EEO to the electro-oxidation method while reducing or eliminating the need for handling hydrogen peroxide and for UV lamp maintenance may be advantageous. Other processes for treatment of NDMA are described by Schaefer et al. in US 2007/0119786 and by Keefer et al. in U.S. Pat. No. 4,535,154.

MTBE is often present as a fuel additive to enhance the octane value of gasoline and to eliminate the need for lead in the gasoline. Gasoline may contain up to 15% MTBE. Many ground water sites and surface water sources have been found to be polluted with MTBE. In 2001, a U.S Geological Survey established that about 0.5% of community water systems contained MTBE levels at a concentration of 35 μg/l. MTBE is a suspected carcinogen and may adversely affect the taste and odor of water at concentrations between 15 μg/l and 50 μg/l. MTBE presents an environmental concern due to its abundance, high solubility, very low Henry constant and very low affinity for common adsorbents. Using air stripping or GAC to remove MTBE from water may be very expensive. Therefore, an alternative, more cost effective technology for MTBE degradation may be advantageous.

1,4-dioxane (or dioxane) is used as a stabilizer for chlorinated solvents and often remains as a residual contaminant following remediation of the highly volatile solvent. Similar to MTBE, dioxane is highly soluble and thus is capable of causing widespread ground water pollution. 1,4 dioxane, like MTBE, is a suspected carcinogen. Since 1,4 dioxane is highly miscible in water with a low Henry constant, and cannot be readily removed by air stripping or adsorption, AOT is generally considered to be the BAT for dioxane contaminated water.

Thus, there is a need for a method and system for efficient removal of VOC contaminants such as NDMA, MTBE, and dioxane from water.

It is an object of the present invention to provide for degradation of VOC pollutants in an aqueous environment.

Other aims and advantages of the present invention will become apparent after reading the present invention and reviewing the accompanying drawings.

### SUMMARY OF THE INVENTION

There is thus provided, in accordance with some embodiments of the present invention, an electrode including an elongated conductive metal support and a layer of carbon fibers supported by, and in electrical contact with, the elongated conductive metal support such that ends of fibers of the layer of carbon fibers extend beyond the conductive metal support.

Furthermore, in accordance with some embodiments of the present invention, the layer of carbon fibers comprises a carbon fiber fabric.

Furthermore, in accordance with some embodiments of the present invention, the carbon fiber fabric comprises a woven carbon fiber cloth.

Furthermore, in accordance with some embodiments of the present invention, the elongated conductive metal support comprises two metal strips sandwiching a portion of the layer of carbon fibers.

There is further provided, in accordance with some embodiments of the present invention, an electrode array that includes a plurality of electrically connected substantially parallel electrodes, each electrode including an elongated conductive metal support and a layer of carbon fibers supported by, and in electrical contact with, the elongated conductive metal support such that ends of fibers of the layer of carbon fibers extend beyond the conductive metal support.

Furthermore, in accordance with some embodiments of the present invention, the electrodes are connected by at least one conductive rod.

Furthermore, in accordance with some embodiments of the present invention, an end of the conductive rod is covered by a cap with a curved outward-facing surface.

Furthermore, in accordance with some embodiments of the present invention, the electrode array includes at least one conductive spacer in contact with two adjacent electrodes of the plurality of electrically connected substantially parallel electrodes.

Furthermore, in accordance with some embodiments of the present invention, the layer of carbon fibers of the electrode includes a carbon fiber fabric.

Furthermore, in accordance with some embodiments of the present invention, the carbon fiber fabric includes a woven carbon fiber cloth.

Furthermore, in accordance with some embodiments of the present invention, the elongated conductive metal support of an electrode of the plurality of electrically connected substantially parallel electrodes includes two metal strips sandwiching a portion of the layer of carbon fibers.

Furthermore, in accordance with some embodiments of the present invention, the electrode array includes a conducting rod for connecting the array to a voltage source.

There is further provided, in accordance with some embodiments of the present invention, a method for treating contaminated water. The method includes: providing an electrode array above an upper surface of the contaminated water, the electrode array including a plurality of electrically connected substantially parallel electrodes, each electrode including an elongated conductive metal support and a layer of carbon fibers supported by, and in electric contact with, the elongated conductive metal support such that ends of fibers of the layer of carbon fibers extend beyond the conductive metal support. The method further includes providing a ground electrode in electric contact with the contaminated water, such that the contaminated water is located between the ground electrode and the electrode array, with a gap of air between the upper surface and the electrode array. The method further includes applying voltage to the electrode array to cause corona discharge in the gap.

Furthermore, in accordance with some embodiments of the present invention, the applied voltage is a pulsed voltage.

There is further provided, in accordance with some embodiments of the present invention, a method for treating water contaminated with NDMA. The method includes producing corona discharge between an electrode and water contaminated with NDMA.

Furthermore, in accordance with some embodiments of the present invention, the corona discharge is produced above a surface of the water contaminated with NDMA.

Furthermore, in accordance with some embodiments of the present invention, the corona discharge is produced by applying a voltage to the electrode wherein the electrode includes an electrode array including a plurality of electrically connected substantially parallel electrodes, each electrode including an elongated conductive metal support and a layer of carbon fibers supported by, and in electric contact with, the elongated conductive metal support such that ends of fibers of the layer of carbon fibers extend beyond the conductive metal support.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 is a schematic diagram of a water purification system in accordance with embodiments of the present invention;

FIG. 2A shows a corona electrode in accordance with embodiments of the present invention;

FIG. 2B shows an enlarged rotated view of the foremost corner of the corona electrode shown in FIG. 2A;

FIG. 3 shows tabulated results of treatment of contaminated water with the system shown in FIG. 1;

FIG. 4 shows a graph of the concentration of MTBE in water as a function of treatment time with the system shown in FIG. 1; and

FIG. 5 shows a graph of the change in concentration resulting of treatment of contaminated well water with the system shown in FIG. 1 as a function of treatment time.

### DETAILED DESCRIPTION OF EMBODIMENTS

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

A system for water purification, in accordance with embodiments of the present invention, includes a corona discharge electrode. A corona discharge may react with the air to create radicals, ozone, or UV radiation that may facilitate dissociation of contaminant molecules. Corona discharge occurs when a high voltage potential is applied to a corona electrode, creating a high electric field, typically over 10⁶ V/cm. For example, such a high electric field may be achieved by applying a voltage to an electrode with a sharpened (to a micro-scale size) end. Corona discharge can be either positive or negative, depending on the polarity of the applied voltage. Typically, maximum density of non-thermal plasma formation in the vicinity of the corona electrode may be achieved by applying a positive voltage to the corona electrode. Corona discharge may be created either by application of a constant direct current (DC) voltage, or by application of a pulsed voltage. Typically, a series of short duration (e.g. nanosecond time scale), high-voltage, and high-current pulses generated by a high-voltage generator may be applied. By application of a series of short pulses of a positive high voltage to the electrode, an intense corona discharge may be achieved. Typically, the corona intensity (in units of energy per unit time) achieved with a pulsed voltage is greater than the maximum corona intensity achievable (without short-circuiting the electrodes) with an applied DC voltage. Increasing the intensity of the corona discharge may enable more efficient generation of free radicals and ozone for purification of water. Water to be purified may be caused to flow near (typically under) the electrodes, The generated free radicals and ozone may then react with contaminants in the water to disrupt the molecular structure of the contaminants.

In order to provide for efficient utilization of electrical energy, a large corona electrode cross-sectional area is desirable. The area of the corona electrodes may be made large enough such that the impedance of the corona discharge impedance approximately matches the impedance of the high-voltage generator. In addition, increasing the area of the electrodes may increase the area of the water surface exposed to the generated corona discharge. Increasing the area of the water surface area exposed to the corona discharge may facilitate diffusion of generated free radicals and ozone into the water. Increased exposed area may also increase the volume of water exposed to UV radiation created by the discharge.

A corona electrode in accordance with embodiments of the present invention includes an array of electrodes arranged to have a large cross-sectional area. Each electrode includes a layer of carbon fiber electrodes. Such carbon fiber electrodes are described by Krasik in WO 2008/114267, incorporated herein by reference. Each such a carbon fiber layer includes a plurality of carbon fibers that extend outward from the electrode. Typically, the fibers are arranged in strips or ribbons, each typically having dimensions of a few millimeters. Each strip includes a large number of individual carbon fibers, each fiber typically having a diameter of a few micrometers. Such fiber strips may continuously provide a sharp, highly curved, narrow electrode tip as corona discharge degrades the electrode. Thus, an electrode including a large area of densely packed carbon fibers may efficiently create a corona discharge.

Carbon fiber strips may be formed into a carbon fiber fabric. In a carbon fiber fabric, a large number of carbon fibers, or strips each made of a large number of carbon fiber strands, are formed into a continuous substance. A carbon fiber fabric may be easier to work with and handle, and to incorporate into an electrode, than individual carbon fibers. Typically, the carbon fiber fabric may be constructed such that a significant fraction of the fibers are arranged approximately parallel to one another. For example, carbon fiber strips or ribbons may be woven together to form a carbon fiber cloth. The warp and woof of such a carbon fiber cloth may include substantially parallel fibers. Typically, when incorporated into an electrode in accordance with embodiments of the present invention, one end of the cloth extends outward from the electrode. The outward extending end may typically be partially unraveled in order to ensure that the outward facing ends of the carbon fibers are exposed. Thus, an exposed end of the carbon fiber cloth typically includes a large number of fibers oriented substantially parallel to one another. Such a carbon fiber cloth may be incorporated into the electrodes. The fiber strands woven into the carbon fiber cloth are typically arranged linearly at a linear density of about 5 strands per centimeter. Each strand, approximately 0.2 cm in diameter, typically includes approximately 3000 fibers and may have a volume resistivity of about 3 Ω·cm-10 Ω·cm. Typically, the thickness of a carbon fiber cloth incorporated into each electrode is approximately 0.5 cm thick. When voltage is applied to the fibers to create corona discharge, those fibers that extend outward beyond the neighboring fibers are generally the fibers that emit. During operation, an emitting fiber typically loses material and recedes inward. When the fiber no longer extends beyond the neighboring fibers, other nearby fibers may then emit in its place. Since a fiber strand typically includes several thousands of individual fibers, the operation lifetime of such an electrode may be substantially longer than the operation lifetime of a needle electrode. Also, the electric field formed by the sharp edges of the fibers may create a more intense corona discharge than the corona discharge produced by a typical knife-type electrode.

In a water purification system in accordance with embodiments of the present invention, water to be purified flows over a flat horizontal plate. The plate may serve as a ground electrode with respect to the corona electrode. Typically, the water is caused to flow in a shallow layer (about half a centimeter deep) over the plate. As the water flows over the plate, a pulsed voltage may be applied to the corona electrodes, creating a pulsed corona discharge above the surface of the flowing water. The flowing water may be collected in a tank.

A water purification system in accordance with embodiments of the present invention may include additional components. For example, water to be purified may flow through the additional components to be subjected to further purification processes. For example, the system may include a Venturi injector for facilitating the introduction of ozone enriched air into the water.

One or more catalyst materials may be provided in various parts of the system to increase the effectiveness of one or more purification processes. For example, the plate, which serves as a ground electrode, may include a catalyst to facilitate oxidation caused by ozone and UV radiation. Similarly, the system may include a catalyst in a component, such as a mixer tank or bubbling tank, through which the water flows after flowing through the injector. The catalyst after the injector may facilitate oxidation by the injected ozone. For example, a typical catalyst may include a metal or metal oxide.

Reference is now made to the accompanying figures.

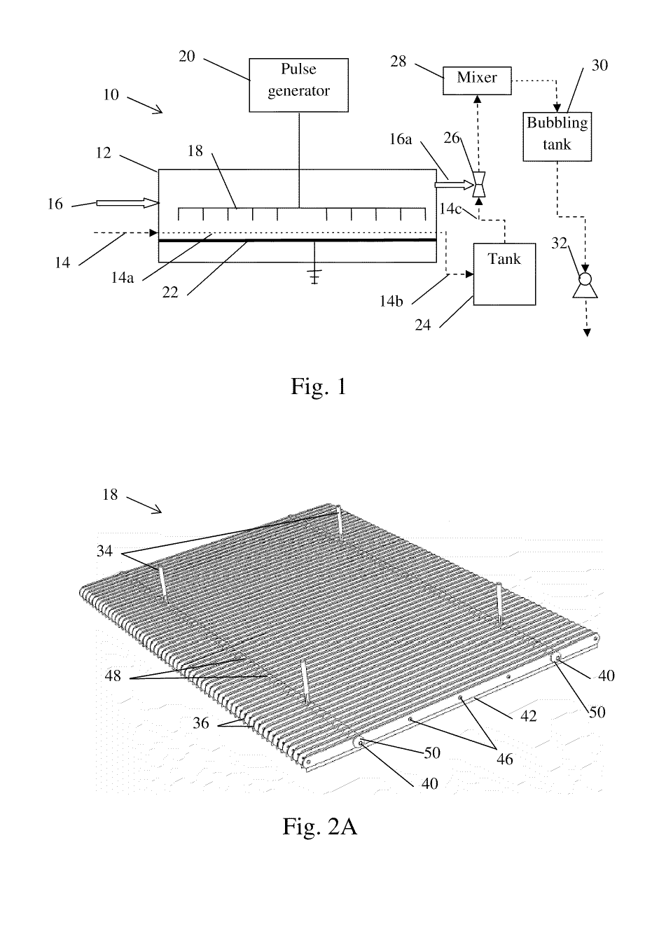

FIG. 1 is a schematic diagram of a water purification system in accordance with embodiments of the present invention. Water purification system 10 includes corona discharge unit 12. Water 14 and air 16 may be caused to flow into corona discharge unit 12. Water 14 flows in a shallow water layer 14a over grounded plate 22. Corona electrode 18 is connected to electric pulse generator 20. When electric pulse generator 20 generates electric pulses, corona electrode 18 may generate a corona discharge above shallow water layer 14a. After exposure to corona discharge, exposed water 14b may flow into water tank 24.

Water held in water tank 24 may then be further purified. For example, pump 32 may pump water 14c from water tank 24 may be pumped through injector 26. In injector 26, ozone enriched air 16a from corona discharge unit 12 may be injected (e.g. Venturi injection) into water 14c. The water may then be pumped through static mixer 28 to enhance mixing and dissolving of the ozone-enriched air into water 14c. A bubbling tank 30 may be included to enable the ozone-enriched air to separate from water 14c after purification. After passing through bubbling tank 30, water 14c may be stored or may be transferred to a water supply system.

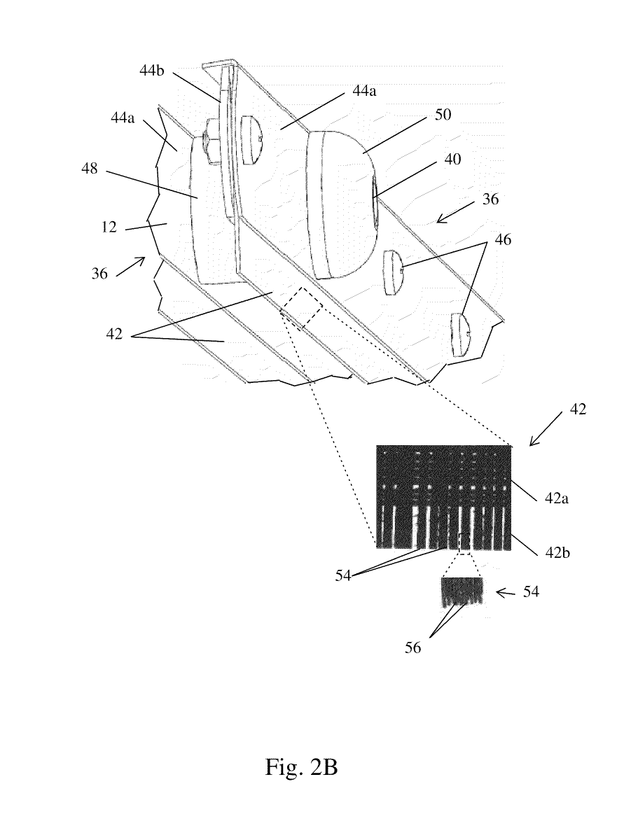

FIG. 2A shows a corona electrode in accordance with embodiments of the present invention. FIG. 2B shows an enlarged rotated view of the foremost corner of the corona electrode shown in FIG. 2A. Corona electrode 18 may be supported and connected to an electric pulse generator or other electric voltage source by support rods 34. Support rods 34 are typically constructed so as to enable efficient electrical conduction from electric pulse generator 20 (shown schematically in FIG. 1) to corona electrode 18. Corona electrode 18 contains a plurality of electrode blades 36 connected to one another via connecting rods 40. Typically, corona electrode 18 includes at least two connecting rods 40. Connecting rods 40 connect electrode blades 36 to one another both mechanically and electrically. Typically, corona electrode 18 is supported such that support rods 34 extend vertically upward and electrode blades 36 and connecting rods 40 are horizontal. Therefore, the side of corona electrode 18 that typically faces the water will be referred to as the lower or bottom side. The side of corona electrode 18 from which support rods 34 extend will be referred to as the upper or top side. Typically, the bottom ends of electrode blades 36 are positioned less than 2 cm above a grounded plate 22 (shown schematically FIG. 1) oriented parallel to corona electrode 18.

Alternatively, an array of electrode blades may be physically mounted and electrically connected to one another by other means known in the art for mechanically supporting and electrically connecting an array of electrodes. For example, the electrode blades may be electrically connected to one another by one or more conducting plates or strips in electrical contact with the electrode blades. Alternatively, the ends of the electrode blades may be supported by, or inserted into, a structure that provides both mechanical support and electrical contact.

Each electrode blade 36 includes a section of carbon fiber fabric such as carbon fiber cloth 42. Typically, the bulk of carbon fiber cloth 42 includes woven section 42a. Typically, woven section 42a includes carbon fiber strands 54 woven in a crisscross pattern. An outward facing edge 42b of carbon fiber cloth 42 may be partially unraveled so that it includes an approximately linear array of substantially parallel carbon fiber strands 54. Each carbon fiber strand 54 typically includes a large number of individual carbon fibers 56.

Typically, an electrode blade 36 may include two layers of carbon fiber cloth 42. Carbon fiber strands 54 of outward facing edge 42b of carbon fiber cloth 42 are typically oriented vertically when corona electrode 18 is mounted for use. Carbon fiber cloth 42 in electrode blade 36 is sandwiched between metal strip 44a and metal strip 44b. Metal strips 44a and 44b are typically held together by screws 46. Alternatively, metal strips 44a and 44b may be held together by clips, pins, rivets, adhesive, or any other fastener known in the art for connecting plates and enabling electric conduction between the connected plates.

Electrode blades 36 may be maintained by spacers 48 at fixed distances from one another along connecting rods 40. Typically, spacer 48 is in the form of a cylinder with a hollow bore along its axis. The diameter of the bore enables the spacer fit over connecting rod 40. Typically, spacer 48 includes a conducting material. For example, spacer 48 may be constructed out of a conducting metal. In this manner, spacer 48 may assist in maintaining good electrical contact between adjacent electrode blades 36. The outer ends of connecting rods 40 that may extend outward beyond an endmost electrode blade 36 may be surrounded by rod caps 50. Rod caps 50 are shaped such that no sharp edges or points extend outward. For example, all outward facing surfaces of rod cap 50 may be curved. For example, rod cap 50 may have a general substantially hemispherical shape. Elimination of edges or projections at the ends of connecting rods 40 may assist in preventing unwanted corona or sparking at the ends of connecting rods 40.

A typical corona electrode 18 may include for example, 140 electrode blades 36 spaced approximately 2 cm apart. Typically, each electrode blade 36 is a few centimeters high and up to 40 cm long. Thus, a typical corona electrode 18 may have an equivalent length L (total length of all of the electrode blades) of about 56 m. The typical total electrode surface area (electrode thickness multiplied by equivalent length) may provide for satisfactory electric pulse distribution and effective oxidant penetration into the water below.

An appropriate value of equivalent length L may be selected on the basis of such factors as the flow velocity V of the water, the depth d of the flowing water, and the diffusion constant D of the free radicals in the water. For example, a value of L may be selected in accordance with the formula: L≧d²V/D.

Typically, corona electrode 18 is connected to a high-voltage generator such as pulse generator 20. A typical pulse generator 20 may produce, for example, high voltage pulses at frequency of up to 1000 Hz. The amplitude of a typical high voltage pulse may be as great as 40 kV, with a typical rise time of 18 ns, and typical full width half maximum duration of 40 ns. A typical maximum energy of a pulse may be about 1 J.

The application of a positive high-voltage pulse to corona electrode 18 may cause the formation of intense corona discharge. Typically, the most intense corona discharge is formed in the vicinity of the outermost ends of the carbon fibers where the electric field is strongest. The use of carbon fiber electrodes enables achievement of extremely high electric fields at the end of the carbon fibers due to their micrometer-sized dimensions. The large number of closely spaced fibers, on the other hand, enables the corona electrode to operate over a longer lifetime than other commonly used electrodes. The corona discharge's dense and non-thermal plasma may generate intense UV radiation, ozone, free radicals, and H₂O₂ in the vicinity of the carbon fibers. Typically, the power dissipated in the corona discharge may reach several tens of megawatts. In additional, the large electrode surface area may result in efficient impedance matching between the corona discharge and the high-voltage generator, maximizing electrical efficiency of the system.

A corona discharge system in accordance with embodiments of the present invention may be used to purify water containing contaminants such as, for example, NDMA, MTBE and 1,4 dioxane. When so applying the corona discharge system, a pulsed corona discharge may be preferable over a DC corona discharge. For example, a short duration pulse (for example, tens of nanoseconds duration) may enable creation of extremely high electric field strengths (10⁶ V/cm-10⁷ V/cm). Such field strength may not be attainable with an applied DC voltage due to the risk of electrical breakdown. Creation of such an extremely large electric field may enable formation of a dense and uniform corona. The typical pulsed power may reach hundreds of megawatts under the electrode where water to be treated may be caused to flow. The short time of each pulse may enable placement of the corona electrode close to the water surface (e.g. within a few millimeters of the surface) without formation of electrical breakdown between the surface and the electrode. The small distance between the corona electrode and the water surface may enable highly efficient and powerful irradiation of the water by generated UV radiation. The short distance may facilitate diffusion of created ozone and free radicals into the water. In addition, the small distance between the corona electrode and the water surface may cause slight turbulence in the water, further enhancing the diffusion process. Energetic electrons generated by the high electric field may enable formation of a uniform volume gas discharge near the water surface. Some of the energetic electrons may penetrate the water to a depth of up to several tens of micrometers, further contributing to the breakdown of contaminants.

For example, consider a corona discharge unit that is 80 cm long through which water flows at a rate of about 1 cm/s. With a pulse rate of 500 Hz, water flowing through the unit, may thus be exposed to a total of about 4·10⁴ corona discharge pulses. During this time, diffusion processes may enable effective mixing of water, ozone, free radical, and H₂O₂ molecules. Since the diffusion coefficient for water is about 0.25 cm²/s, the thickness of the mixed layer then is about 4.5 cm. Thus, if the layer of water is about 5 mm deep, the water may undergo about 9 mixing processes. In a system in accordance with embodiments of the present invention, water flow velocity and depth of the water layer may be adjusted to optimize the water treatment.

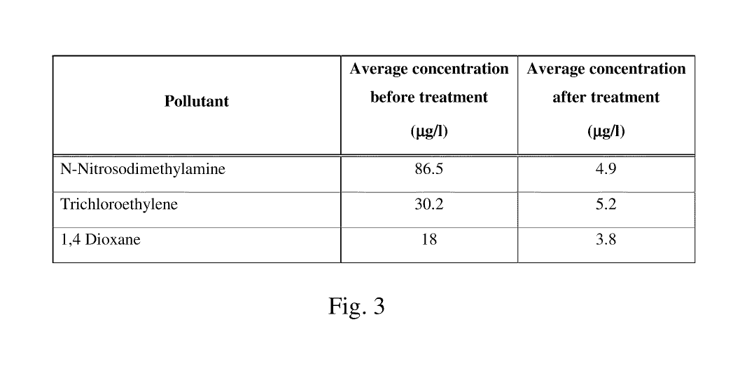

Experiments have demonstrated that use of a corona discharge water treatment system in accordance with embodiments of the present invention, may effectively treat water contaminated with NDMA, MTBE and 1,4 dioxane. FIG. 3 shows tabulated results of treatment of contaminated water with the system shown in FIG. 1. During the experiment, average water temperature was about 22° C., pH was about 6.7, turbidity was 0.27 NTU, total organic carbon (TOC) was <0.5 mg/l, electrical conductivity (EC) was 250 μS/cm, the water flow rate was continuous at 570 l/h, and the pulse frequency was 1000 Hz. As shown in FIG. 3, the concentrations of all three contaminants were reduced significantly.

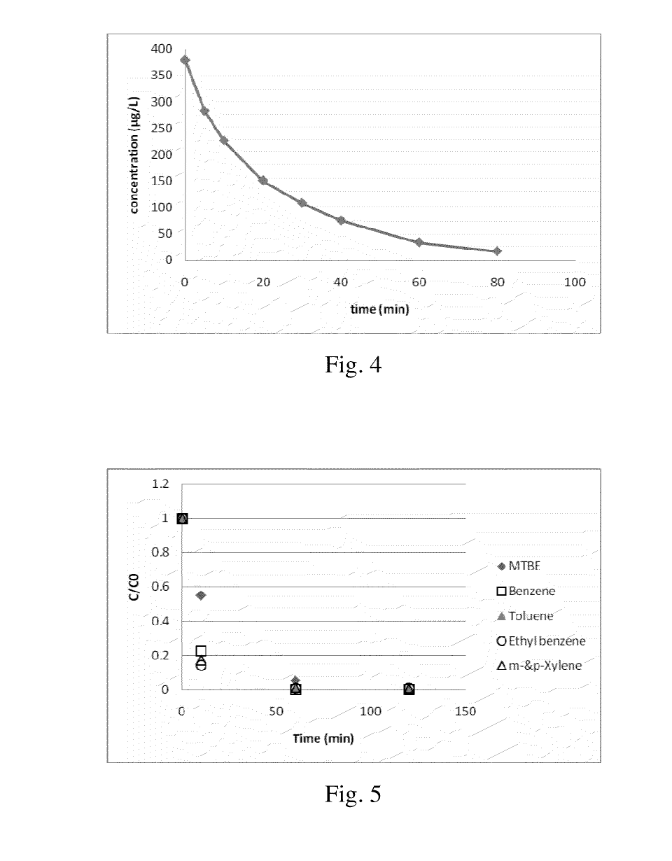

FIG. 4 shows a graph of the concentration of MTBE in water as a function of treatment time with the system shown in FIG. 1. During this experiment, water was recycled through the system. The overall water volume was 200 l, and the water recirculation rate was 480 l/h. Air flow through the system was 1100 l/h, the initial MTBE concentration was 380 μg/1, and the pulse frequency was 600 Hz. The water temperature was 25° C., water alkalinity was 175 mg/l of CaCO₃, water turbidity was 2 NTU, and the pH was 7.6.

FIG. 5 shows a graph of the change in concentration resulting of treatment of contaminated well water with the system shown in FIG. 1 as a function of treatment time. Water from a shallow well near a gasoline station in Tel Aviv, Israel, was treated with a corona discharge reactor as described above. The well water initially had a high concentration of the fuel compounds MTBE (39 ppm) and the combination of benzene, toluene, ethylbenzene, and xylenes, collectively referred to as BTEX (5 ppm), and extremely high turbidity (over 300 NTU). The water temperature was 31° C., the pH was 7, and the bath volume was 13 1.

Modifications to the water purification system shown in FIG. 1 may also provide for effective treatment of water contaminated with NDMA, MTBE, dioxanes, or other VOC contaminants. For example, a pulsed or other voltage may be applied to an array of electrodes arranged throughout a volume of space. Such application of the voltage may generate corona discharge in regions of the space. Spraying contaminated water, or introducing an aerosol of contaminated water through a region of generated corona discharge may expose the water in an efficient manner to the UV radiation, ozone, and other products of the generated corona discharge.

Thus, a system and method is provided for effective corona discharge treatment of contaminated water, and in particular, water contaminated with NDMA.

It should be clear that the description of the embodiments and attached Figures set forth in this specification serves only for a better understanding of the invention, without limiting its scope.

It should also be clear that a person skilled in the art, after reading the present specification could make adjustments or amendments to the attached Figures and above described embodiments that would still be covered by the present invention.

What is claimed is:

1. An electrode comprising:
an elongated conductive metal support; and
a layer of carbon fibers supported by, and in electrical contact with, the elongated conductive metal support such that ends of fibers of the layer of carbon fibers extend beyond the conductive metal support.

2. An electrode as claimed in claim 1, wherein the layer of carbon fibers comprises a carbon fiber fabric.

3. An electrode as claimed in claim 2, wherein the carbon fiber fabric comprises a woven carbon fiber cloth.

4. An electrode as claimed in claim 1, wherein the elongated conductive metal support comprises two metal strips sandwiching a portion of the layer of carbon fibers.

5. An electrode array comprising a plurality of electrically connected substantially parallel electrodes, each electrode including an elongated conductive metal support and a layer of carbon fibers supported by, and in electrical contact with, the elongated conductive metal support such that ends of fibers of the layer of carbon fibers extend beyond the conductive metal support.

6. An electrode array as claimed in claim 5, wherein electrodes of said plurality of electrically connected substantially parallel electrodes are connected by at least one conductive rod.

7. An electrode array as claimed in claim 6, wherein an end of said at least one conductive rod is covered by a cap with a curved outward-facing surface.

8. An electrode array as claimed in claim 5, comprising at least one conductive spacer in contact with two adjacent electrodes of said plurality of electrically connected substantially parallel electrodes.

9. An electrode array as claimed in claim 5, wherein the layer of carbon fibers of an electrode of said plurality of electrically connected substantially parallel electrodes comprises a carbon fiber fabric.

10. An electrode array as claimed in claim 9, wherein the carbon fiber fabric comprises a woven carbon fiber cloth.

11. An electrode array as claimed in claim 5, wherein the elongated conductive metal support of an electrode of said plurality of electrically connected substantially parallel electrodes comprises two metal strips sandwiching a portion of the layer of carbon fibers.

12. An electrode array as claimed in claim 5, comprising a conducting rod for connecting the array to a voltage source.

13. A method for treating contaminated water, the method comprising:
providing an electrode array above an upper surface of the contaminated water, the electrode array including a plurality of electrically connected substantially parallel electrodes, each electrode including an elongated conductive metal support and a layer of carbon fibers supported by, and in electric contact with, the elongated conductive metal support such that ends of fibers of the layer of carbon fibers extend beyond the conductive metal support;
providing a ground electrode in electric contact with the contaminated water, such that the contaminated water is located between the ground electrode and the electrode array, with a gap of air between the upper surface and the electrode array; and
applying voltage to the electrode array to cause corona discharge in the gap.

14. A method as claimed in claim 13, wherein the applied voltage is a pulsed voltage.

15. A method for treating water contaminated with NDMA, the method comprising producing corona discharge between an electrode and water contaminated with NDMA.

16. A method as claimed in claim 15, wherein the corona discharge is produced above a surface of the water contaminated with NDMA.

17. A method as claimed in claim 16, wherein the corona discharge is produced by applying a voltage to the electrode wherein the electrode includes an electrode array including a plurality of electrically connected substantially parallel electrodes, each electrode including an elongated conductive metal support and a layer of carbon fibers supported by, and in electric contact with, the elongated conductive metal support such that ends of fibers of the layer of carbon fibers extend beyond the conductive metal support.
